(19) United States
(12) Patent Application Publication
(10) Pub. No.: US 2018/0183578 A1
(43) Pub. Date: Jun. 28, 2018

(54) PROVISIONING KEYS FOR VIRTUAL MACHINE SCALING

(71) Applicant: Intel Corporation, Santa Clara, CA (US)

(72) Inventors: Somnath Chakrabarti, Portland, OR (US); Vincent R. Scarlata, Beaverton, OR (US); Mona Vij, Hillsboro, OR (US); Carlos V. Rozas, Portland, OR (US); Ilya Alexandrovich, Yokneam Illit (IL); Simon P. Johnson, Beaverton, OR (US)

(73) Assignee: Intel Corporation, Santa Clara, CA (US)

(21) Appl. No.: 15/391,268

(22) Filed: Dec. 27, 2016

(51) Int. Cl. H04L 9/08; H04L 9/32

(52) U.S. Cl. CPC H04L 9/083; H04L 9/3247; H04L 9/0861

(57) ABSTRACT

A secure key manager enclave is provided on a host computing system to send an attestation quote to a secure key store system identifying attributes of the key manager enclave and signed by a hardware-based key of the host computing system to attest to trustworthiness of the secure key manager enclave. The secure key manager enclave receives a request to provide a root key for a particular virtual machine to be run on the host computing system, generates a secure data structure in secure memory of the host computing system to be associated with the particular virtual machine, and provisions the root key in the secure data structure using the key manager enclave, where the key manager enclave is to have privileged access to the secure data structure.

### TECHNICAL FIELD

This disclosure relates in general to the field of computer security and, more particularly, to secure enclaves within a computing system.

### BACKGROUND

Software and services can be deployed over the Internet. Some services may be hosted on virtual machines to allow flexible deployment of a service. A virtual machine is an emulation of a computing system and can allow the service to migrate between or be launched simultaneously on multiple physical server systems. Software services may communicate data with other systems over wireline or wireless network. Some of this data may include sensitive content. While encryption and authentication may be utilized to secure communications between systems, trust may be required between the systems in order to facilitate such transactions. Malicious actors have employed techniques such as spoofing, man-in-the-middle attacks, and other actions in an attempt to circumvent safety measures put in place within systems to secure communications. Failure to establish a trusted relationship may make traditional communication security tasks ineffective.

### BRIEF DESCRIPTION OF THE DRAWINGS

FIG. 1 is a simplified schematic diagram of an example system including a host system to host one or more virtual machines in accordance with one embodiment;

FIG. 2 is a simplified block diagram of an example system including an example host platform to host one or more virtual machines supporting secure enclaves in accordance with one embodiment;

FIG. 3 is a simplified block diagram representing application attestation in accordance with one embodiment;

FIG. 4 is a simplified block diagram representing scaling of a deployment in an example cloud system in accordance with one embodiment;

FIG. 5 is a simplified block diagram representing provisioning and use of a virtual machine root key in accordance with one embodiment;

FIG. 6 is a simplified block diagram representing another example of provisioning and use of a virtual machine root key in accordance with one embodiment;

FIG. 7 is a simplified flow diagram illustrating an example technique involving the provisioning of a virtual machine root key;

FIG. 8 is a block is a block diagram of an exemplary processor in accordance with one embodiment;

FIG. 9 is a block diagram of an exemplary mobile device system in accordance with one embodiment; and

FIG. 10 is a block diagram of an exemplary computing system in accordance with one embodiment.

Like reference numbers and designations in the various drawings indicate like elements.

### DETAILED DESCRIPTION OF EXAMPLE EMBODIMENTS

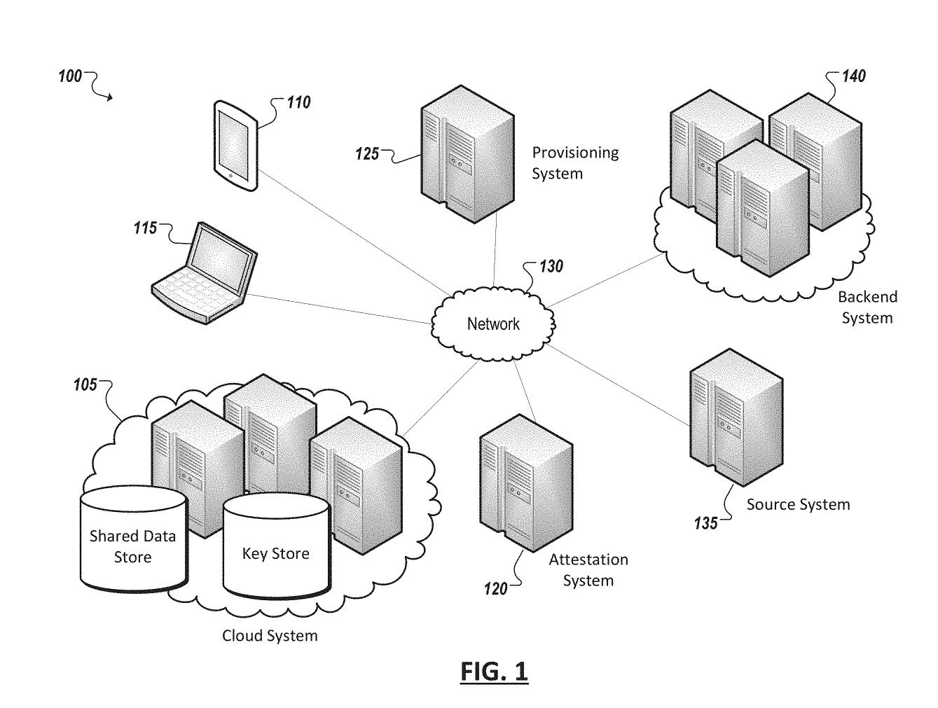

FIG. 1 is a simplified block diagram illustrating an example embodiment of a computing environment 100 including an example cloud system 105. The cloud system 105 can facilitate on-demand and distributed computing resource, which in some cases may be made available to various consumers. The cloud system 105 may include multiple computing resources, which may be selectively utilized to host various applications, data, and services. For instance, the cloud system 105 may be composed of multiple, distinct host computing systems, which may each be used to host one or more virtual machines. A virtual machine, within this disclosure, may refer to a virtual machine, container, or other virtual execution environment in which another software application, program, microservice, or software component may be hosted and run. In some implementations, virtual machines may emulate a private server (e.g., of a customer or other consumer), and the virtual machines may be deployed to host various applications and services. The cloud system 105 may include a controller, or scaling manager, to allow the amount of resources of the cloud dedicated to a particular application, service, and/or consumer to be scaled-up (i.e., allocate more resources to the service) to adjust to increasing demand (or a predicted increase in demand). Likewise, the scaling manager may scale-down (i.e., subtract) the cloud system resources of an application in response to a real or predicted decrease in demand for the application, among other examples.

In some cases, one or more consumer source systems (e.g., 135) may interact with cloud system 105 resources or other host systems 110, 115 to act as a source for various applications, data, virtual machine images, and even secrets and keys. For instance, a source system 135 may provide at least a portion of a virtual machine image to run a particular application instance to cloud system 105 in connection with the hosting and scaling of the particular application on the cloud system 105. Likewise, the source system may allow consumers to specify particular secret data and/or keys, which a particular consumer may desire to be used in connection with an application and/or virtual machine sourced from the source system 135, among other examples.

In some implementations, a cloud system may include host computing systems (or platforms) to be equipped with functionality to support secure logical components, or enclaves, to allow virtual machines to be hosted, which themselves include such secure enclaves, allowing applications and data hosted on the virtual machine to be secured through one or more secure enclaves. Indeed, the virtual machine of such a system may likewise include secure enclaves. A secure enclave may be embodied as a set of instructions (e.g., implemented in microcode or extended microcode) that provides a safe place for an application to execute code and store data inside in the context of an operating system (OS) or other process. An application that executes in this environment may be referred to as an enclave. Enclaves are executed from a secure enclave cache. In some implementations, pages of the enclave may be loaded into the cache by an OS. Whenever a page of an enclave is removed from the secured cache, cryptographic protections may be used to protect the confidentiality of the enclave and to detect tampering when the enclave is loaded back into the cache. Inside the cache, enclave data may be protected using access control mechanisms provided by the processor. The enclave cache may be where enclave code is executed and protected enclave data is accessed.

In some implementations, the enclave cache may be located within the physical address space of a platform but can be accessed only using secure enclave instructions. A single enclave cache may contain pages from many different enclaves and provides access control mechanism to protect the integrity and confidentiality of the pages. Such a page cache may maintain a coherency protocol similar to the one used for coherent physical memory in the platform. The enclave cache can be instantiated in several ways. For instance, the cache may be constructed of dedicated SRAM on the processor package. The enclave cache may be implemented in cryptographically protected volatile storage using platform DRAM. The cache may use one or more strategically placed cryptographic units in the CPU uncore to provide varying levels of protection. The various uncore agents may be modified to recognize the memory accesses going to the cache, and to route those accesses to a crypto controller located in the uncore. The crypto controller, depending on the desired protection level, generates one or more memory accesses to the platform DRAM to fetch the cipher-text. It may then process the cipher-text to generate the plain-text, and satisfy the original cache memory request.

In some implementations, when a platform loads an enclave it may call a system routine in the operating system. The system may attempt to allocate some pages in the enclave cache. In some implementations, if there is no open space in the cache, the OS may select a victim enclave to remove. The system may add secure enclaves control structure (SECS) to the cache. With the SECS created, the system may add pages to the enclave as requested by the application. A secure enclave SECS is said to be active if it is currently loaded into the cache. In some implementations, a secure enclave may be implemented in a virtual machine. A corresponding OS, virtual machine manager (VMM), etc., may be responsible for managing what gets loaded into the EPC. In some implementations, while loading an enclave page into the EPC, the OS/VMM may inform the CPU the whereabouts of the SECS for that page, except when the page under consideration itself is an SECS. When the page being loaded is not an SECS, the SECS corresponding to the page may be located inside the EPC. Before loading any page for an enclave, the OS/VMM may load the SECS for that enclave into the EPC.

Secure enclaves may be used, in some instances, to seal, or secure, private or secret data utilized by an application or virtual machine, for instance, by encryption using hardware-based or other encryption keys. In some implementations, a specialized secure enclave may be provided to manage keys for a virtual machine (e.g., in connection with a key store provided on the cloud system 105). Secure enclaves may be further utilized to perform attestation of various components of a virtual machine and the application(s) it hosts. Attestation may be the process of demonstrating that a piece of software has been established on the platform especially to a remote entity. In the case of secure enclaves, attestation is the mechanism by which a remote platform establishes that software is running on an authentic (i.e., secure enclave enabled) platform protected within an enclave prior to trusting that software with secrets and protected data. The process of attestation can include measurement of the secure enclave and its host, storage of the measurement results (e.g., in a corresponding SECS), and reporting of measurements (with potentially additional information) through quotes to prove the authenticity of the secure enclave to another entity.

In some implementations, one or more attestation systems (e.g., 120) may be provided, which may receive attestation data, or “quotes,” generated by secure enclaves running on host systems of the cloud system 105 or even other non-cloud host systems (e.g., 110, 115) to prove or attest to the authenticity and security (and other characteristics) of another application or enclave of the host. An attestation system 120 may process data, including signatures, included in the quote to verify the trustworthiness of the secure enclave (and its platform) and confirm the attestation based on the received quote.

In general, host systems (e.g., 105, 110, 115) can host applications and services and attestation of the host system may be utilized to establish the trustworthiness of both an application or service, a secure enclave provided on the host, as well as the host system itself. In the case of applications or services implemented through one or more virtual machines hosted on one or more host systems (e.g., of cloud system 105), secure enclaves may likewise be provided in the virtual machines and the applications they host to similarly allow these “host” virtual machines (and their applications) to reliably and securely attest to their authenticity and trustworthiness. As noted, attestations may be facilitated through quotes that identify attributes of the system, an application, and/or an enclave that is being attested to through the quote. The quote may additionally be signed or include data that has been signed by a cryptographic key (or key pair), cipher, or other element (collectively referred to herein as “key”) from which the attestation system can authenticate or confirm the trustworthiness of the quote (and thereby also the application or enclave attested to by the quote). Such keys can be referred to as attestation keys. A provisioning system 125 can be utilized to securely provision such attestation keys on the various host devices (e.g., 105, 110, 115), virtual machines, and/or enclaves. Provisioning systems and services may also be utilized to facilitate the provisioning or generation of sealing keys for use in sealing secret data generated or entrusted to an application or virtual machine. Such secret data may be sealed (e.g., in a shared storage element within the cloud system 105) such that it may securely maintained and made available for later access, such as when a virtual machine and application are deconstructed, or scaled-down, and later re-instantiated during scale-up, among other examples.

In some cases, attestation can be carried out in connection with a client-server or frontend-backend interaction (e.g., over one or more networks 130) between an application hosted on a host system (e.g., 105, 110, 115) and a backend service hosted by a remote backend system (e.g., 140). Sensitive data and transactions can take place in such interactions and the application can attest to its trustworthiness and security to the backend system (and vice versa) using an attestation system (e.g., 120). In some implementations, the attestation system itself can be hosted on the backend system. In other cases, a backend system (e.g., 140) (or even another host device in a peer-to-peer attestation) can consume the attestation services of a separate attestation system (e.g., 105). Attestation to a backend system 140 can facilitate access to higher privileges, sensitive data, keys, services, etc. that are restricted to other systems unable to attest to their trust level. Indeed, secret data maintained at an application may include secrets entrusted with an application or virtual machine by a backend service (e.g., 140) based on successful attestation of the application or virtual machine, among other examples.

A provisioning system 125 can maintain a database or other repository of certificates mapped to various host platforms (e.g., 105, 110, 115) or virtual machines equipped to implement trusted execution environments, or secure enclaves. Each of the certificates can be derived from keys, such as root keys, established for the host devices or virtual machines. Such keys may themselves be based on persistently maintained, secure secrets provisioned on the host devices during manufacture. In the case of virtual machines or platforms employing multiple devices (e.g., such as a server architecture) the secret may be established for the virtual machine and platform and registered with a registration system 130, among other examples. The root keys or secrets remain secret to the host platform or virtual machine and may be implemented as fuses, a code in secure persistent memory, among other implementations. The key may be the secret itself or a key derived from the secret. The certificate may not identify the key and the key may not be derivable from the certificate, however, signatures produced by the key (e.g., and included in a quote) may be identified as originating from a particular one of the host platforms or virtual machines for which a certificate is maintained based on the corresponding certificate. In this manner, a host system (e.g., 105, 110, 115) or virtual machines hosted thereon can authenticate to the provisioning system 125 and be provided (by the provisioning system 125) with attestation keys, root keys, sealing keys, and other cryptographic structures, which the provisioning system 125 may further and securely associate with the host device or virtual machine. These attestation keys can then be used by secure enclaves on the corresponding host systems (e.g., 105, 110, 115) or virtual machine to perform attestation for one or more applications or enclaves present on the host device.

Various host platforms may interact with an attestation system (e.g., 120), provisioning systems (e.g., 125), source system (e.g., 135), and backend systems (e.g., 140) over one or more networks (e.g., 130). Networks 130, in some implementations, can include local and wide area networks, wireless and wireline networks, public and private networks, and any other communication network enabling communication between the systems. Further, two or more of attestation systems (e.g., 120), provisioning systems (e.g., 125), and backend systems (e.g., 140) may be combined in a single system. Communications over the networks 130 interconnecting these various systems (e.g., 105, 110, 115, 120, 125, 135, 140) may be secured. In some cases, a secure enclave on a host (e.g., 105, 110, 115, etc.) may initiate a communication with an attestation system 120, provisioning systems (e.g., 125), and/or source systems (e.g., 135) using a secure channel, among other examples.

In general, “servers,” “devices,” “computing devices,” “host devices,” “user devices,” “clients,” “servers,” “computers,” “platforms,” “environments,” “systems,” etc. (e.g., 105, 110, 115, 120, 125, 135, 140, etc.) can include electronic computing devices operable to receive, transmit, process, store, or manage data and information associated with the computing environment 100. As used in this document, the term “computer,” “computing device,” “processor,” or “processing device” is intended to encompass any suitable processing device adapted to perform computing tasks consistent with the execution of computer-readable instructions. Further, any, all, or some of the computing devices may be adapted to execute any operating system, including Linux, UNIX, Windows Server, etc., as well as virtual machines adapted to virtualize execution of a particular operating system, including customized and proprietary operating systems. Computing devices may be further equipped with communication modules to facilitate communication with other computing devices over one or more networks (e.g., 130).

Host devices (e.g., 110, 115) can further include computing devices implemented as one or more local and/or remote client or end user devices, such as application servers, personal computers, laptops, smartphones, tablet computers, personal digital assistants, media clients, web-enabled televisions, telepresence systems, gaming systems, multimedia servers, set top boxes, smart appliances, in-vehicle computing systems, and other devices adapted to receive, view, compose, send, or otherwise interact with, access, manipulate, consume, or otherwise use applications, programs, and services served or provided through servers within or outside the respective device (or environment 100). A host device can include any computing device operable to connect or communicate at least with servers, other host devices, networks, and/or other devices using a wireline or wireless connection. A host device, in some instances, can further include at least one graphical display device and user interfaces, including touchscreen displays, allowing a user to view and interact with graphical user interfaces of applications, tools, services, and other software of provided in environment 100. It will be understood that there may be any number of host devices associated with environment 100, as well as any number of host devices external to environment 100. Further, the term “host device,” “client,” “end user device,” “endpoint device,” and “user” may be used interchangeably as appropriate without departing from the scope of this disclosure. Moreover, while each end user device may be described in terms of being used by one user, this disclosure contemplates that many users may use one computer or that one user may use multiple computers, among other examples.

A host system (e.g., 105) can be further configured to host one or more virtual machines. For instance, a host device may include a virtual machine monitor (VMM) and/or hypervisor, which may be utilized to host virtual machines on the host device. A host device may additional include or set aside encrypted or otherwise secured memory to facilitate secured enclaves, including secured enclaves to be hosted on or in connection with one or more virtual machines hosted on the host system (e.g., 105), among other examples.

While FIG. 1 is described as containing or being associated with a plurality of elements, not all elements illustrated within system 100 of FIG. 1 may be utilized in each alternative implementation of the present disclosure. Additionally, one or more of the elements described herein may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

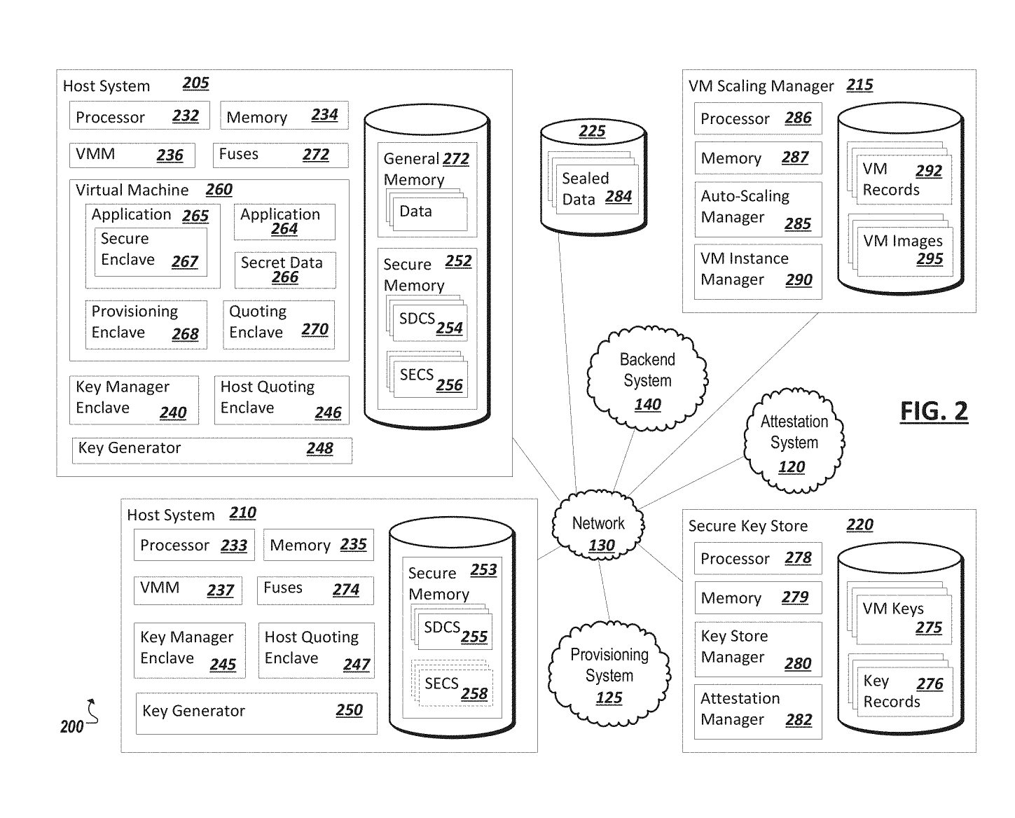

Turning to the example of FIG. 2, a simplified block diagram 200 is shown illustrating a system or computing environment that includes a cloud system composed of one or more host computing systems (e.g., 205, 210). At least some of the host computing systems (e.g., 205, 210) may be configured to support one or more secure. In some cases a host system (e.g., 205, 210) may be composed of multiple interconnected devices presenting logically as a single platform (e.g., a multi-processor server system). A host system (e.g., 205, 210) may generally include one or more processor apparatus (e.g., 232, 233), one or more memory elements (e.g., 234, 235), and other components to host scalable applications and services within a cloud service. For instance, a host system (e.g., 205, 210) may additionally include a VMM (e.g., 236, 237) running on an operating system of host system 120 or running directly on the hardware (e.g., 232, 233) of the host system (e.g., outside of the host operating system). The VMM (e.g., 236) may be used to host one or more virtual machines (e.g., 260), which may be used to host one or more applications or services (e.g., 264, 265). One or more of these applications (e.g., 264, 265) may be configured to transact or otherwise communicate with one or more remote backend services (e.g., 140) over one or more networks (e.g., 130). Transactions between an application (e.g., 265) and a backend system (e.g., 140) may involve the transmission of sensitive data (e.g., 266) or the establishment of secured or trusted communication channels. Security of and access to such data and communication channels may involve the attestation of the application 265, its host virtual machine 260 and even host system 205. Accordingly, in some implementations, an application may be provided with a secure enclave 267, or application enclave, for use in securing application data and communications between the application (e.g., 265) and other applications, services, or system remote or local to the hosting system (e.g., 205). Secure enclaves can be implemented in secure memory 252 (as opposed to general memory 272) and utilizing secured processing functionality of at least one of the processors (e.g., 205) of the host system to implement private regions of code and data to provide certain secured or protected functionality of the application.

To facilitate the implementation of secure enclave and support functionality (e.g., key generation through key generation logic 248, 250), machine executable code or logic, implemented in firmware and/or software of the host system (such as code of the CPU of the host), can be provided on the host system 205 that can be utilized by applications or other code local to the host system to set aside private regions of code and data, which are subject to guarantees of heightened security, to implement one or more secure enclaves on the system. For instance, a secure enclave can be used to protect sensitive data from unauthorized access or modification by rogue software running at higher privilege levels and preserve the confidentiality and integrity of sensitive code and data without disrupting the ability of legitimate system software to schedule and manage the use of platform resources. Secure enclaves can enable applications to define secure regions of code and data that maintain confidentiality even when an attacker has physical control of the platform and can conduct direct attacks on memory. Secure enclaves can also enable a host system platform to measure a corresponding application's trusted code and produce a signed attestation, rooted in the processor, that includes this measurement and other certification that the code has been correctly initialized in a trustable environment (and is capable of providing the security features of a secure enclave, such as outlined in the examples above). Generally, secure enclaves (and other secured enclaves described herein) can adopt or build upon principles, features, and functionality described, for instance, in the Intel® Software Guard Extensions (SGX) Programming Reference, among other example platforms.

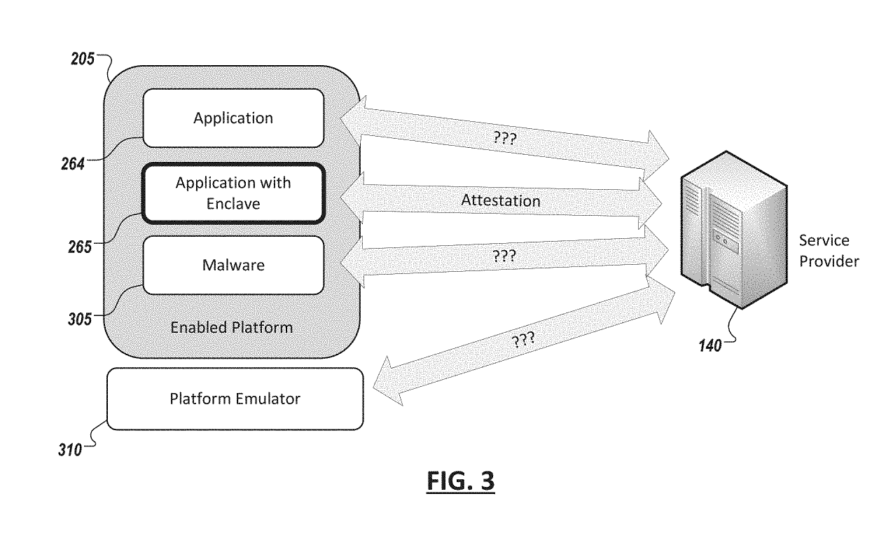

Turning briefly to FIG. 3, an application enclave can be provided on an application (e.g., 265) to protect all or a portion of a given application and allow the application (and its security features) to be attested to. For instance, a service provider 140, such as a backend service or web service, may prefer or require that clients, with which it interfaces, possess certain security features or guarantees, such that the service 140 can verify that it is transacting with who the client says it is. For instance, malware (e.g., 305) can sometimes be constructed to spoof the identity of a user or an application in an attempt to extract sensitive data from, infect, or otherwise behave maliciously in a transaction with the service 140. Signed attestation (or simply “attestation”) can allow an application (e.g., 265) to verify that it is a legitimate instance of the application (i.e., and not malware). Other applications (e.g., 264) that are not equipped with a secure application enclave may be legitimate, but may not attest to the service provider 140, leaving the service provider in doubt, to some degree, of the application's authenticity and trustworthiness. Further, host system platforms (e.g., 205) can be emulated (e.g., by emulator 310) to attempt to transact falsely with the service 140. Attestation through a secure enclave can guard against such insecure, malicious, and faulty transactions.

Returning to FIG. 2, attestation can be provided on the basis of a signed piece of data, or “quote,” that is signed using an attestation key securely provisioned on the platform or virtual machine hosting the application. For instance, in the implementation of FIG. 2, an application 265 may be provided that is provided with a secure application enclave 267 for securely maintaining data and/or securely communicating in transactions with a backend system 140. Additional secured enclaves (e.g., 268, 270) can be provided (i.e., separate from the secure application enclave 267) to measure or assess the application 265 and its enclave 267, sign the measurement (included in the quote), and assist in the provisioning one or more of the enclaves with keys for use in signing the quote and establishing secured communication channels between enclaves or between an enclave and an outside service or system (e.g., 120, 125, 140, 220, etc.). For instance, one or more provisioning enclaves (e.g., 268) can be provided to interface with a corresponding provisioning system (e.g., 125) to obtain attestation keys for use by a quoting enclave 270 and/or application enclave 267. One or more quoting enclaves 270 can be provided to reliably measure or assess an application 265 and/or the corresponding application enclave 267 and sign the measurement with the attestation key obtained by the provisioning enclave 268 through the corresponding provisioning service system 125.

A host system (e.g., 205, 510) may be equipped with additional secure enclaves (e.g., 240, 245, 246, 247) to support the instantiation of secure enclaves (e.g., 267, 268, 270) with the respective virtual machines (e.g., 260) hosted by the system (e.g., 205). Keys may be provided in one or more of these host-based enclaves (e.g., 240, 245, 246, 247). Moreover, such host-based enclaves may also engage in attestation operations so as to be provisioned with a corresponding key, attest to its or the host platform's trustworthiness, to generate and register keys for one or more VMs (e.g., 260), among other example uses. Keys utilized by host-based enclaves (e.g., 240, 245, 246, 247) may be derived from or rely on an attestation based on a root key or other hardware-secured secrets specific to the host platform. For instance, secrets of a host platform (e.g., 205, 210) may be secrets set in or derived from fuses (e.g., 272, 274) of the platform during manufacturing or may be a secret derived from hardware-based secrets of multiple devices making up a host platform (e.g., fuses of individual processors in a multi-processor host platform), among other examples. A virtual machine, however, does not have dedicated hardware as it is “manufactured” virtually in software on the fly. Accordingly, a host system (e.g., 205, 210) may provide additional functionality to support the creation of secure secrets, or root keys, of a virtual machine at creation of the virtual machine, with these secure secrets then being available for use by one or more of the enclaves (e.g., the provisioning enclave 268) to support attestation of the trustworthiness of the VM's enclaves to various services (e.g., 120, 125, etc.).

In one implementation, instruction sets of host platforms may be extended to provide host-based key manager enclaves (e.g., 240, 245) for use in providing root keys and/or sealing keys for virtual machines instantiated on the host (e.g., 205, 210). A key manager enclave (e.g., 240, 245) may possess functionality to generate and register root keys for virtual machines instantiated using a VMM (e.g., 236, 237) of the host platform (e.g., 205, 210). Further the key manager enclave (e.g., 240, 245) may possess read and write privileges (e.g., access not afforded to other software or enclaves of the platform) to a particular page of secure (e.g., encrypted) memory (e.g., 252, 253) embodying a control structure (e.g., secure domain control structure (SECS)) (e.g., 254, 255) in which virtual machine keys obtained or generated by the key manager enclave (e.g., 240, 245) may be stored. Indeed, multiple virtual machines may be instantiated on a single host system (e.g., 205, 210) and the key manager enclave (e.g., 240, 245) may generate or otherwise obtain key and other secrets for each respective virtual machine and store the keys in a respective secure control structure (e.g., 254, 255). Additional control structures (e.g., 256, 258) may also be stored in secure memory (e.g., 252, 253), such as a secure enclave control structure (SECS), which may each be associated with a particular secure enclave and used to securely store information and measurements corresponding to the secure enclave (which may be used by a quoting enclave to include in a quote to prove the identity and trustworthiness of the corresponding secure enclave), among other examples.

For hardware-based root keys, each root key may be set during manufacture and may be concurrently registered (e.g., by the manufacturer) as belonging to a particular device and being a legitimate key. However, virtual machine keys generated on the fly by a key manager enclave (e.g., 240, 245) (or other secure enclave) may only be known to the key manager enclave itself, and would thereby be of little use for attesting to authenticity of the virtual machine or its component enclaves (as provisioning and attestation systems would have no knowledge of the key (or possess certificates based on the key). Accordingly, a key registration system may be provided through which virtual machine root keys created by key manager enclaves (e.g., 240, 245) may be registered. For instance, a key manager enclave (e.g., 240, 245) can attest of its trustworthiness to a registration service by using a quote signed by a root key of its host system 205, 210 (using host quoting enclave 246, 247), for which the registration system possesses or has access to a corresponding certificate, to allow the registration system to verify that the key (and its corresponding certificate) is from a legitimate and secure key management enclave hosted by a trusted platform (e.g., 205, 210). The registration system may then provide a certificate corresponding to the virtual machine root key generated by a key manager enclave (e.g., 240, 245) to a provisioning system, with which a provisioning enclave (e.g., 268) may interface to obtain an attestation key for use by a quoting enclave (e.g., 270) of the same virtual machine 260. In other instances, a source system may pre-generate keys (e.g., 275) that are intended for use as VM keys and store the same in a secure key store system 220. A key manager enclave (e.g., 240, 245) can access these keys by attesting to its trustworthiness to the secure key store system 220 and requesting a key for a particular virtual machine (e.g., 260) for which the key manager enclave (e.g., 240) manages keys. The first time a key is requested for a particular virtual machine by a key manager enclave, the key store 220 can permanently associate the key it issues in response to the particular virtual machine (e.g., in a key record 276). Specific keys 275 maintained by the key store may be associated with and assigned to particular virtual machine IDs, application IDs, customer IDs, or combinations of customer/VM, customer/application, etc., and these associations, once they are made, may be documented in key records 276. If a key manager enclave (e.g., 240) requests a key for a particular virtual machine (e.g., 260) that has already been assigned to the virtual machine, the secure key store system 220 may provide the pre-assigned key to the requesting key manager enclave to allow the same key to be utilized for subsequent instances of the same virtual machine (e.g., in connection with a scale-up relaunching the virtual machine following the virtual machine being torn down in connection with a prior scale-down).

In one implementation, a secure key store system 220 may be provided that includes one or more processor apparatus 278, one or more memory elements 279, and key store manager logic 280 to provide functionality for storing, defining associations between VM keys 275 and VMs and customers (in key records 276), and providing copies of keys 275 to authorized systems. The secure key store 220 may be associated with a particular cloud system provider and serve as a repository for all VM keys 275 (and other keys and secrets) for use with VM instantiations within a particular cloud system. For instance, all key manager enclaves (e.g., 240, 245) provided on hosts within the particular cloud system may be pointed to the secure key score 220 for the registration and obtaining of VM keys for VM deployments on their respective hosts (e.g., 205, 210). A secure key store system 220 may additionally include an attestation manager 282 to validate attestation requests, or quotes, from key manager enclaves (e.g., 240, 245) and other entities requesting a VM key or other secret maintained at the secure key store. Through attestation, the secure key store 220 may lock allow only trusted entities (e.g., trustworthy key manager enclaves (e.g., 240, 245) to access keys stored in the key store 220. To validate an attestation quote, the attestation manager 282, in some implementations, may interface with outside attestation systems. For instance, a quote may include a signature by a particular key (e.g., a platform attestation key based on the root key of a particular platform (e.g., 205, 210) in the cloud system) and the attestation manager 282 can query an attestation system possessing a certificate corresponding to the signing key to validate whether the key that signed the quote is a valid key and/or associated with a host platform, virtual machine, enclave, or other entity said to be associated with the signature (i.e., in the quote). The attestation manager 282 can thereby base its validation decision on validation results received from an outside attestation system. In other cases, the secure key store may itself maintain relevant certificates (e.g., for the collection of host systems (e.g., 205, 210) within the cloud system) and access these certificates directly to prove whether a signature contained in an attestation quote is authentic or not, among other example implementations.

Root keys, whether based in hardware of a host platform (e.g., 205, 210) or obtained through a key manager enclave (e.g., 240, 245) may serve as the basis for other keys used on the host. For instance, a provisioning key may be derived from a root key and used by a host or VM provisioning enclave to obtain an attestation key for use in signing quotes by a host or VM quoting enclave (e.g., 246, 247, 270). A root key may also or alternatively be used to derive a sealing key for a platform or virtual machine. A sealing key may be used by a secure enclave to seal sensitive data, for instance, within the enclave, local memory, or external (e.g., shared) data stores (e.g., 225). A sealing key may be used to encrypt and lock the sealed data (e.g., 284), such that the sealed data may only be unlocked by the holder of the sealing key. As noted above, data may be secured by sealing the data in off-host storage (e.g., 225). This can be used, for instance, to seal keys, user data, and other sensitive data of a virtual machine before the virtual machine is torn down, allowing the sealed data (e.g., 284) to be available again should the same virtual machine be re-instantiated, with the re-instantiated virtual machine using the same sealing key to unseal the sealed data (e.g., 284) for use again on the virtual machine (and its component secure enclaves, applications, etc.).

A cloud system may additionally include a virtual machine scaling manager 215 implemented using one or more processing apparatus 286, one or more memory elements 287, and components including, for instance, an auto-scaling manager 285 and a VM instance manager 290. The auto-scaling manager 285 may include machine-executable logic to monitor demand for cloud system resources by various virtual machines and applications. In some cases, multiple different consumer entities (or customers) and application may use and even compete for cloud resources. As one application or customer's need for a resource decreases, the resource may be released to both make the resource available to another application or consumer and allow the previous user of the resource to make more efficient use of the resource.

A service or application of a customer may be run on virtual machines instantiated on cloud resource, such as various host systems (e.g., 205, 210) capable of running one or more virtual machines at a time. The auto-scaling manager 285 can determine that the number of virtual machines used to implement a particular application or service (e.g., for a particular one of multiple customers served by the cloud system) should be scaled up or down depending on demand or other policies. Auto-scaling can take place predictively, such that the auto-scaling manager may predict, based on history or trends in usage of the present deployment of the application, that more or less (or the same) amount of resources should be used in the upcoming future. Alternatively, the auto-scaling manager 285 can dynamically and reactively scale-up or -down based on events detected for one or more application deployments monitored by the VM scaling manager 215. As a need for more instances of an application and hosting VM are identified by the auto-scaling manager, a VM instance manager 290 may identify one or more VM records 292 identifying images 295 of the VM instances that are to be deployed on additional cloud system resources to scale-up the deployment. The VM records 292 may further indicate whether a particular VM image has been deployed and whether any VM keys exist for the corresponding VM instance. A VM instance may be an instance of a same type of VM, which may host substantially the same components, applications, etc. VM images 295 may be stored at the VM scaling manager 215 (or another utility) and may include images 295 for multiple different VM instances of multiple different VM types (e.g., used to host various collections of applications and components). Upon direction of the auto-scaling manager, or upon a request from a customer or other manager of an application deployed using the cloud system, the corresponding VM images 295 may be identified and loaded on one or more host computers within the cloud system to implement an application deployment or scale up an existing deployment. Likewise, the auto-scaling manager 285 can determine that virtual machine instances for a particular application or customer should be scaled down and orchestrate the tear down of some of the virtual machines used in the deployment.

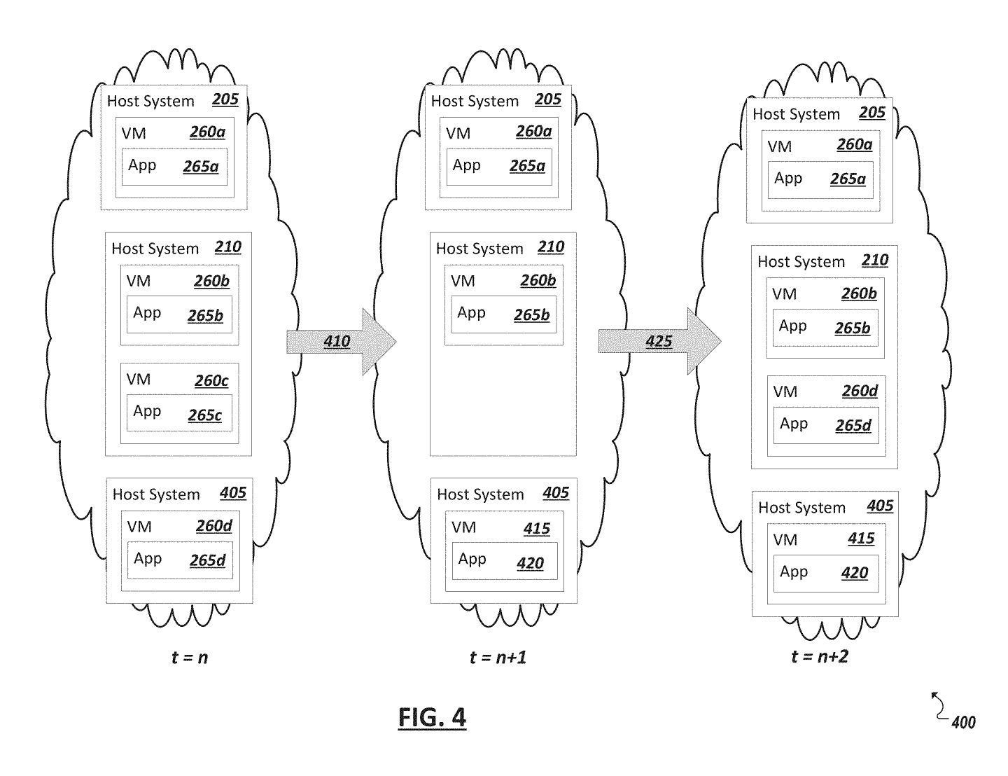

Turning to the simplified block diagram 400 of FIG. 4, an example is shown of a cloud system used to implement an application or service using a collection of virtual machines (e.g., 260a-d) hosted on multiple host systems (e.g., 205, 210, 405) within the cloud system of a particular cloud service provider. At a first time t=n, four VMs 260a-d may be instantiated on host systems 205, 210, 405, each VM 260a-d hosting a respective instance of or portion of an application deployed using the cloud system. After a span of time (resulting in time t=n+1), a auto-scaling manager may determine that demand is or will be decreasing, resulting in scaling-down 410 of the deployment, resulting in the tearing down of VMs 260c and 260d. Further, scaling down VM 260d results in capacity in host system 405, which may be claimed by another application's deployment (or even another customer), such that VM 415 hosting a different application 420 is instantiated on host system 405. After another span of time (resulting in time t=n+2), an auto-scaling manager of the cloud system may determine that demand for the particular application is again increasing, resulting in scaling-up 425 of the deployment to re-instantiate the virtual machine instance 260d. However, in this example, virtual machine instance 260d is re-instantiated on a different host system 210 than before the scale-up. Indeed, in typical cloud systems, it is not uncommon for the same virtual machine instances to migrate from host to host during operation and to be re-instantiated (following an earlier tear down) to another host, as multiple host systems may be provided within the cloud system equally capable of flexibly hosting any variety of VM or application supported by the cloud system.

While the example of FIG. 4 illustrates the flexibility provided through automatically scaling (dynamically or predictively) a service deployment within hosts of a cloud system, this same example can illustrate some of the example issues that may arise for services reliant on a root key whereon other keys, sealed data, enclaves, and application features may be based. As noted above, root keys and/or sealing keys of a VM (e.g., 260a-d) may be based on or derived from a key rooted in hardware of its host (e.g., 205, 210, 405). For instance, in one example, a sealing key used in VM 260d may be derived from a root key of host system 405. When VM 260d is scaled-down (at 410), a secure enclave on the VM 260d may seal certain sensitive data used by an application 265d in the VM 260d in an external storage for secure storage and later access (e.g., the next time the VM instance 260d is instantiated). However, in the example of FIG. 4, when the deployment scales-up (at 425) the image of VM instance 260d is loaded onto a different host system 210. Accordingly, when a key generator attempts to re-derive the sealing key, it attempts to derive the sealing key from the root key of the new hardware (210) instead of the hardware of host system 405. The result is a new sealing key, which is unable to unseal the data sealed at the scale-down event 410, which was sealed using a sealing key derived from the hardware of host system 405. Accordingly, full re-instantiation of the VM instance 260d on host system 210 would fail as sealed data, which the VM 260d and/or its application(s) 265d and enclave(s) rely on is locked until the next time the VM instance 260d happens to be instantiated on the original host system 405 where the sealing key was derived. In some implementations, a requirement may be defined that VMs that utilize keys and enclaves reliant on a hardware-based key of its host always be instantiated on that host, but this jeopardizes the flexibility and scalability sought after in a cloud-based deployment. These and other example issues may be addressed in other example implementations where a VM root key is developed that securely follows a VM instance from instantiation to instantiation on potentially multiple different hosts, allowing the VM's reliance on host system-based keys to be severed.

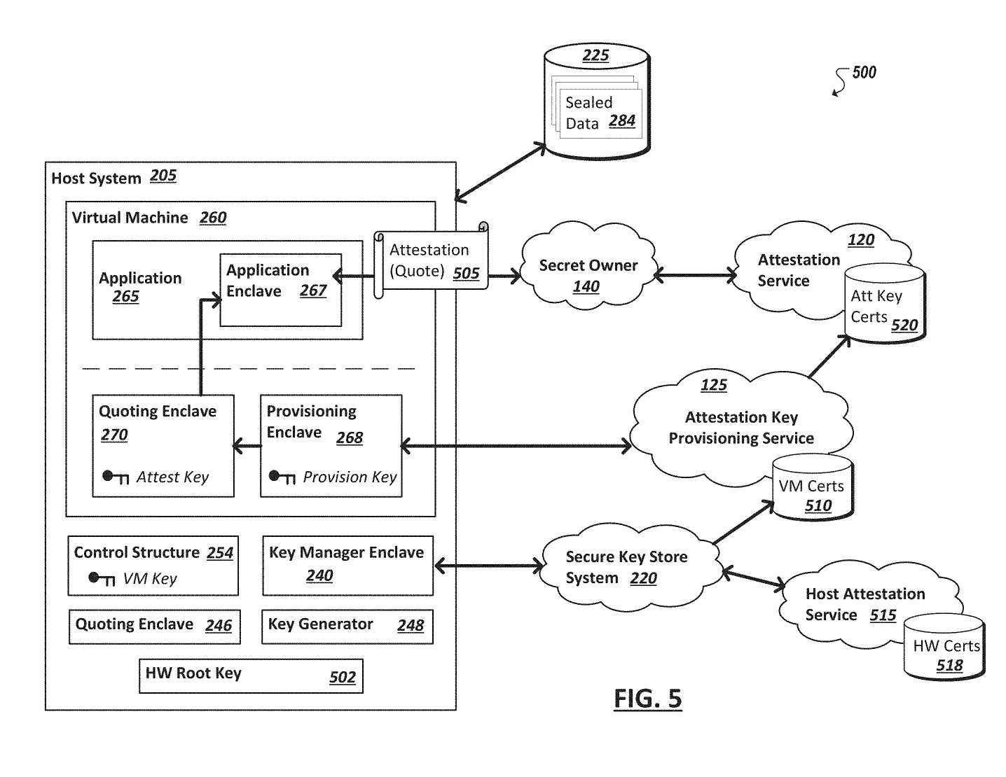

Turning to FIG. 5, a simplified block diagram 500 is shown illustrating example attestations and key provisioning in one example of a virtual machine 260 deployed on a particular host system 205. In this example, the host system 205 hosts a key manager enclave 240 and a secure control structure 256. The key manager enclave may provision the control structure 256 with a VM root key. The key manager enclave 240 may either generate the VM root key from scratch, and then register it and its association with the secure key store system 220, or the key manager enclave 240 may instead extract the VM key from the secure key store 220. In either instance, the key manager enclave 240 may perform an attestation of its trustworthiness to the key store system 220 in order to establish that a VM key it seeks to register for a VM (e.g., 260) is authentic or that the key store system 220 may entrust the key manager enclave 240 with pre-existing keys from the key store 220. As the key manager enclave is hosted directly on the host system 205, the key manager enclave may utilize a quote based on a hardware-based root key 502 of its respective host system 205. Indeed, the host system 102 may include a quoting enclave 246, which may have access to the host root key 502 (or another key derived from the host root key 502) to sign a quote for the key manager enclave 240 in connection with attestation of the key manager enclave 260 with the key store system 220. The key store system 220, to validate a quote received from the key manager enclave 260 may identify a host attestation service 515 that hosts certificates 518 based on and corresponding to various host platform root keys (e.g., 502) (which may have been generated during manufacture of the host platform during setting of the corresponding root key). The host attestation service 515 may validate that the signature was generated by a valid root key of a trusted hardware platform (e.g., 205) and return this result to the key store system 220 to allow the key store system 220 to conclude that the key manager enclave 260 is secure and trustworthy. The key store system 220, in some implementations, may also generate certificates 510 corresponding to VM keys maintained at the key store 220 that have been associated and bound to particular virtual machine instances. These certificates 510 may be provided to various attestation and provisioning services (e.g., 125), which may be utilized to validate subsequent attestations based on signatures signed by the VM root keys (or keys derived from the VM root keys).

With a root key assigned to a VM (e.g., 260) and stored securely in a control structure 256, a VM instance may be fully instantiated on the host system 205. Indeed, as part of the launching a VM instance (e.g., 260) on a host system 205, the key manager enclave 240 may build an associated control structure (e.g., 256) for the VM 260 (which is to only be accessible to the key manager enclave 240 (and certain processor-based instruction set functions (e.g., key generator logic 248)) and load a corresponding VM root key (and potentially other keys) in the data control structure 256. Other keys may be derived for the VM 260 based on the VM root key provisioned in the data control structure 256 (i.e., rather than the hardware root key 502). Indeed, key generation logic 248 may identify when a data control structure (e.g., 256) is associated with a particular VM instance (e.g., 260), for instance, based on the data control structure being associated with the CPU or CPU thread set to run the VM instance. As a result, the key generation logic 248 may determine that a VM root key stored in the data control structure 256 is to be used in lieu of the (e.g., default) host root key 502, among other examples. In some cases, the secure enclaves and hardware of the host platforms may be based on or implement the Intel® SGX platform or a similar platform. For instance, key generation logic 248 may be implemented, in part, using the SGX EGETKEY instruction, among other examples.

In some implementations, the key generation logic 248 may be configured to derive, from either a host root key (e.g., 502) or a VM root key (stored in a data control structure associated with a corresponding VM instance (e.g., 260)) keys for use with an application or VM instance, including sealing keys and a VM provisioning key. In the case of a provisioning key, as shown in the example of FIG. 5, a provisioning key may be derived from a VM root key in data control structure 256 and secured within a provisioning enclave 268 hosted in the corresponding VM instance 260. A provisioning key may be used by the provisioning enclave 268 to authenticate the provisioning enclave 268 to an attestation key provisioning service 125. The attestation key provisioning service 125 can maintain certificates 510 (including certificates for VM root keys maintained at the key store system 220 and passed to the provisioning service 125 from the key store system 220) that map virtual machines (e.g., 260) and/or devices (e.g., by serial number or other identifier) to corresponding certificates, each certificate generated based on root keys set (and kept in secret) in connection with the VM or device platform. In this manner, certificates can be provided, which do not disclose the secret, but allow the presence of the secret to be verified by the certificate holder (e.g., based on a signature generated from the secret or a key based on the secret). Accordingly, the provisioning enclave 268 can provide signed data to the attestation key provisioning service 125 to attest to its authenticity and that it is implemented on a virtual machine (e.g., 220) registered with the registration service 130 and known to possess functionality enabling the instantiation and hosting of a secure, trustworthy enclave (e.g., 268). Based on this attestation, the attestation key provisioning service 125 can negotiate a secure channel between the attestation key provisioning service 125 and the provisioning enclave 268 and provide an attestation key to the provisioning enclave suite in response. Indeed, the data signed by the provisioning enclave 268 can include information (e.g., signed public keys, protocol identifiers, etc.) used to establish the secure channel. The provisioning enclave 268 of the VM 260 can then provision the VM's quoting enclave 270 with the received attestation key, as shown in the example of FIG. 5.

The quoting enclave 270 can measure or identify attributes of one or more applications (e.g., 265) and/or application enclaves (e.g., 267), as well as the virtual machine 260 and/or hosting platform 205 and can provide this information in a quote containing data, at least a portion of which is signed using the attestation key at the quoting enclave 270. For instance, a quote may identify such characteristics as the type and identifier of the virtual machine, type and identifier of the platform processor (e.g., CPU, chipset, etc.), firmware version used by the processor(s), identification and status of any authenticated code modules (ACMs) of the processor(s), presence of trusted boot functionality, firmware of all trusted devices, software versions for any enclave providing security services, among other examples. The quoting enclave then passes the signed quote 505 to the application enclave 267, which can communicate the quote to a backend service (such as through a secret owner 140 (e.g., hosting secrets usable by the application to decrypt data or access content, etc.) to attest the authenticity of the application 265. In this example, the backend service 140 (e.g., “secret owner”) can utilize the services of an attestation service 120, which can receive attestation key certificates 520 and revocation lists generated by the attestation key provisioning service 125 that generated the attestation key used by the quoting enclave 270 of the virtual machine 260. Through these certificates 520, the attestation service 120 can verify the authenticity of the quote based on the signature included in the quote (signed by the attestation key provided by the attestation key provisioning service 125). Upon verifying the authenticity of the quote and further verifying, from the description of the application enclave 267 included in the quote, the characteristics of the application enclave 267 (e.g., that it is a reliably implemented enclave on a capable, secure platform), the attestation service 120 can communicate the results of the attestation to the backend service 140. From these results, the backend service 140 can provide a level of service (or grant/deny service entirely), allow the application 265 (through the application enclave 267) access to particular data owned by the secret owner, establish protected communication channels between the secret owner's system and the application enclave 267, issuance of certificates from a certificate authority, allow sensor-type platforms to pair with a coordination point and/or allow data to be accepted from sensors (e.g., in an Internet of Things system), among potentially limitless other examples, based on whether or not the application is protected by a trustworthy application enclave.

As noted above, a VM root key may also be utilized by key generation logic 248 to derive one or more sealing keys for the VM 260 and/or its component secure enclaves (e.g., 267, 268, 270). For instance, a secure enclave (e.g., 267, 268, 270) of the VM 260 may request key generation logic 248 (e.g., through an EGETKEY instruction) to derive a sealing key for the enclave. For example, application enclave 267 may obtain a sealing key generated from the VM root key for use in sealing user data, keys received from a backend service (e.g., 140), among other examples. Sensitive data may be sealed by a VM-root-key-derived sealing key as the sensitive data is received. In other cases, the sensitive data may be sealed by the sealing key prior to a scale-down or other event resulting in the tear down of the VM 260. Data may be sealed within an image of the VM instance (e.g., 260) itself, in some instances. In other cases, the data may be sealed and written (in its encrypted form) in remote storage (e.g., 225), allowing the sensitive data to be accessed by the re-instantiated VM regardless of the platform on which it is hosted. In some cases, keys of other enclaves of the VM (e.g., the provisioning key and attestation key) may be sealed in the sealed data (e.g., 284). In some examples, the entire image of scaled-down VM instance may be sealed by the sealing key, among other examples.

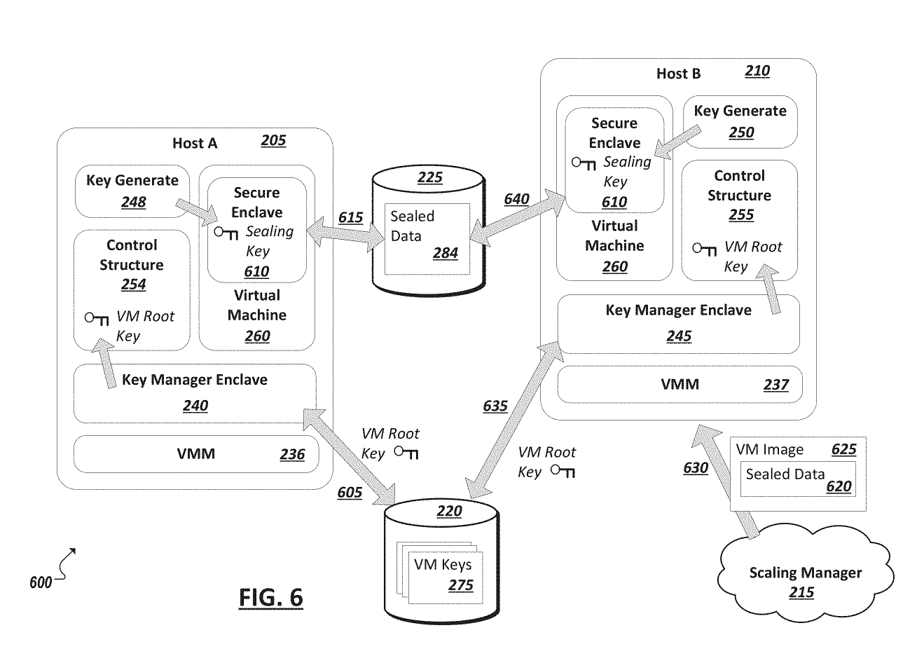

Turning to FIG. 6, a simplified block diagram 600 is shown illustrating the use of a VM root key through a key manager enclave during multiple instantiations of a VM instance within a cloud computing system. In one example, the first time an instance of a virtual machine is to be loaded on a host within a cloud system, a VM root key is to be provisioned for the virtual machine instance. In response to a request to launch the VM image on a particular host system (e.g., 205), a key manager enclave (e.g., 240) may determine whether a VM root key has already been registered for the corresponding VM instance. If no VM root key has been assigned to the VM instance (e.g., it is the first time the VM instance has been loaded), the key enclave manager 240 can determine that a new VM root key is to be provisioned for the VM instance (e.g., before it is launched).

In some cases, the key enclave manager 240 can generate the VM root key from scratch. For instance, the key enclave manager 240 may generate a random root key value or apply another algorithm to generate a root key value that is difficult to predict by unauthorized entities. The key enclave manager 240 may then communicate with a secure key store system (e.g., 220) to register the generated VM root key with the VM instance 260. As noted above, before accepting the VM root key into storage (with keys 275), the secure key store system 220 may test the key enclave manager 240 through an attestation (e.g., based on an attestation key based on a hardware-rooted key of the host system 205). The secure key store 220 may preserve a copy of the generated VM root key and make the VM root key available (e.g., to a key enclave manager (e.g., 240, 245)) the next time the VM instance is launched on the same (e.g., 205) or a different (e.g., 210) host system. The secure key store system 220 may then send confirmation to the key enclave manager 240 that the generated key has been registered as the VM root key of the VM instance 260 and the key enclave manager 240 can build a data control structure (e.g., 254) for the VM instance 260 and write the accepted VM root key to the data control structure 254 for use in connection with the launched VM instance 260.

In other instances, a key enclave manager 240, rather generating a VM root key from scratch for a new VM instance, may request that an unassigned, pre-generated key maintained by the secure key store 220 (in keys 275) be registered with the VM instance. As in the case of a key that is first generated by the key enclave manager 240 and then registered and stored with the key store 220, the key enclave manager 240 may first prove its trustworthiness to the secure key store 220 through an attestation (such as described elsewhere herein). Upon validating that the key enclave manager 240 is trusted, the secure key store system 220 may identify the VM instance to which the VM root key is to be assigned (e.g., by VM identifier, customer identifier, application identifier, or combination thereof). For instance, a request may be sent from the key enclave manager 240 to the secure key store 220 identifying the particular VM instance (e.g., from an ID included in the request to launch the VM instance). In some cases, the request from the key enclave manager 240 to assign and fetch a key corresponding to the identified VM instance may include the attestation quote used by the key enclave manager 240 to attest to the secure key store system 220. The secure key store system 220 may then select a VM key (e.g., a type of key designated in the key enclave manager's 240 request) and permanently associate the selected VM key with the specific VM instance (e.g., identified by a particular identifier). The secure key store system 220 can further send a copy of the selected key to the key enclave manager 240 for adoption as the VM root key for the VM instance (e.g., 260). As with a key generated by the key enclave manager 240, upon receiving the VM root key from the secure key store system 220, the key enclave manager 240 can build a data control structure (e.g., 254) for the VM instance 260 and write the assigned VM root key to the data control structure 254 for use in connection with the launched VM instance 260.

In some cases, the request to launch the VM instance may identify how the key enclave manager 240 is to initially provision (605) the VM root key. Indeed, in some cases, the request to launch the VM may identify whether the key enclave manager 240 is to generate a new key from scratch or use an available key maintained by a secure key store 220. The request may even identify a particular type or form of VM root key to be used. Requests to launch a VM instance, may be received (e.g., from a VM scaling manager 215) and processed at the VMM (e.g., 236, 237) of the host (e.g., 205, 210), and upon identifying that the key enclave manager (e.g., 240, 245) is to be used to provision 605 a VM root key in connection with the launch of the VM instance, the corresponding VMM may send a request to the key enclave manager to provision a particular type of VM root key and/or to use a particular technique (e.g., generate or fetch) to initially provision 605 the VM root key for the VM.

Continuing with the example of FIG. 6, as discussed in previous examples, with a VM root key provisioned in a data control structure 254 for a particular VM instance 260, the VM root key may be used to derive (e.g., using key generation logic 248) provisioning keys and sealing keys for use in the VM 260. For instance, a particular secure enclave 610 may be provisioned with a sealing key derived from the provisioned VM root key. The sealing key may be used, for instance, to seal sensitive data (e.g., 620) of the virtual machine 260 and/or applications running thereon within the corresponding VM image (e.g., 625) and additionally, or alternatively, seal such data (e.g., 284) to a shared data store (e.g., 225). Indeed, a portion of the sensitive data corresponding to a particular VM instance (e.g., 260) may be sealed within the VM image, while the remained is sealed to remote storage (e.g., 225).

After an initial launch of a particular VM instance 260, the VM instance may be torn down (e.g., during a scale-down of a service deployment on the cloud system). When the same VM instance is to be re-instantiated (e.g., during a scale-up), a VM scaling manager 215 may identify an available host system within the cloud system with resources to host the VM instance. While the VM instance may be able to be re-instantiated on the same host system (e.g., 205) on which it was originally launched, this is not necessary, as the VM root key assigned to the VM instance allows the VM instance to be instantiated on any host system with access to the secure key store maintaining the VM root key. For instance, in the example of FIG. 6, the VM scaling manager 215 may determine that the VM instance 260 is to be re-instantiated at a later time on a different host system 210 within the cloud environment. Accordingly, the VM scaling manager 215 may provide the image 625 of the VM instance to the host system 210 with a request 630 to launch the VM 260. The request 630 may additionally identify that a VM root key has been registered for the VM 260 to indicate that the VM key is available to be fetched by an authorized key manager enclave (e.g., 240, 245).

The VMM 237 of the host system 210 may receive the request 630 and generate a request for the key manager enclave 245 to assist with the launching of the VM instance 260 on the host system 210. The request to the key manager enclave 245 can cause the key manager enclave to generate a data control structure 255 to be associated with the resources used to host the VM instance 260 on the host system 210. Further, the key manager enclave may extract an identifier for the VM instance from the request and construct a request and attestation quote to send to the secure key store 220 of the cloud system to fetch the VM root key previously registered for the VM instance from the secure key store 220. Upon attesting to its own trustworthiness, the key manager enclave 245 may be allowed to fetch 635 the same VM root key used in the earlier instantiation of the VM instance on host system 205. The key manager enclave 245 of the new host system 210 may then write the fetched VM root key to the data control structure 255 built for the VM instance and allow the launching of the VM instance on host system 210 to complete, together with the application instances and secure enclaves (e.g., 610) present on the original instantiation of the VM instance.

With the VM root key provisioned in the data control structure, the same provisioning and sealing keys may be re-derived (using key generation logic 250) for use in the re-instantiated VM instance 260 on the host system 210. For instance, the same sealing key used in the previous instantiation of the VM 260 may be re-derived using the VM root key, such that the sealing key may be used to unseal sensitive data and secrets to be used by the VM instance and its component applications and enclaves. In some cases, the sensitive data (e.g., 620) may be unsealed from the VM image 625 itself using the sealing key, while in other or additional cases, sensitive data may be accessed from a shared data repository 225 and unsealed using the re-derived sealing key, among other examples.

In some cases, it may be desirable to limit latency during scaling of an application or service deployment. For instance, it may be desirable to streamline tasks used in the instantiations and re-instantiations of VMs deployed and scaled-up within a cloud system. In some cases, provisioning of keys on a VM (e.g., an attestation key) may be streamlined by sealing a previously provisioned key using a sealing key of the VM, such that the enclave key is simply unsealed rather than re-provisioned (including re-attestation of the corresponding VM, secure enclaves, etc.). Further, attestation and re-attestation of a key manager enclave (e.g., 240, 245) to fetch a VM root key to reestablish a VM instance during scale-up may also introduce costly latency. For instance, in the case of dynamic scale-up, it may be desirable to launch a new VM instance in response to an event or increased demand as quickly as possible. Some implementations may address latency and other example issues arising in auto-scaling of a deployment.

In one example, attestation by a key manager enclave 240, 245 to a secure key store system 220 may only be set to take place when its host platform (e.g., 205, 210) is initially launched. Following this initial attestation, the key manager enclave 240, 245 may simply fetch and register VM root keys with the secure key store system 220 without a re-attestation. For instance, a particular key manager enclave (e.g., 245) may be launched in connection with its host system (e.g., 210) in connection with the launch of a particular virtual machine and application deployment. The particular key manager enclave may attest to the key store system 220 that it is trustworthy and fetch a corresponding VM root key for the particular virtual machine. Later, the particular key manager enclave may receive another request to assist in launching another VM (e.g., from the same or a different VM master image and corresponding to the same or a different application deployment or customer) and simply request and fetch the corresponding VM root key for the other VM from the secure key store 220, thereby limiting the latency added through attestation to the launch of the other VM. Further, as noted above, latency introduced through attestation and provisioning of VM components (e.g., provisioning an attestation key, completing attestation for an application enclave, provisioning secrets onto an application enclave from a backend service, etc.) may also be foregone in the relaunch of a VM instance by unsealing previously-obtained keys, secrets, and other sensitive data sealed using a sealing derivable from the fetched VM root key for the VM instance, among other example features and advantages.

As noted above, in some implementations of a host platform, secure enclaves (including a key manager enclave) may be based on the Intel® SGX platform. The SGX platform may be augmented to support a key manager enclave to generate a secure data control structure. Generation of the data control structure may be automatically scheduled when scheduling a corresponding VM instance. Further, SGX instructions such as EREPORT and EGETKEY may be used to access key stored in the data control structure instead of host hardware keys (e.g., FK0/FK1) in the presence of an associated data control structure, among other features and modifications.

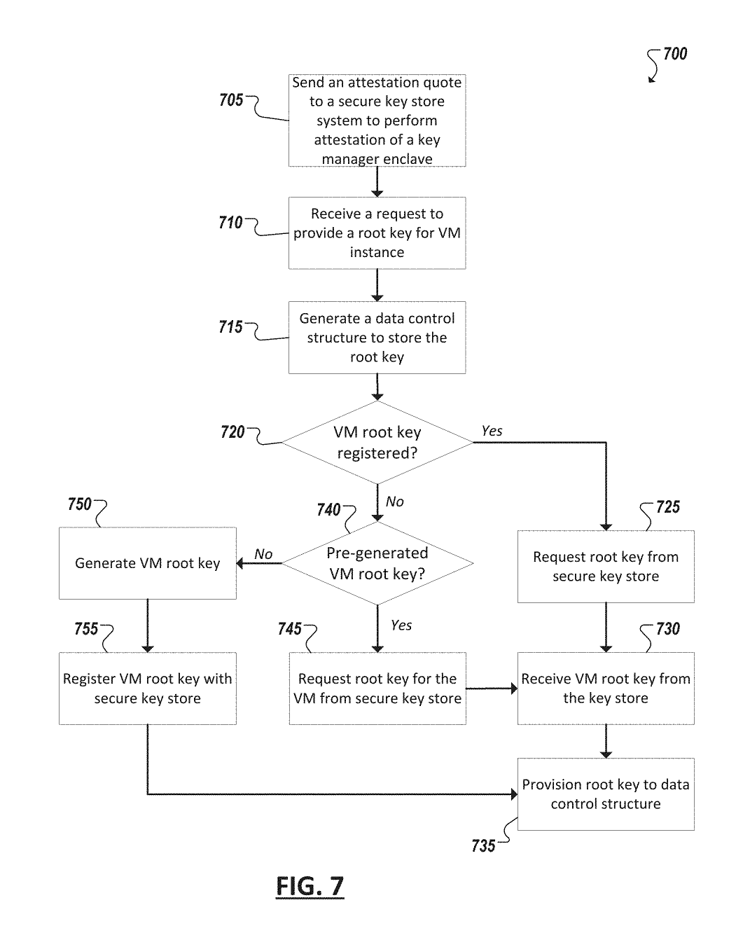

Turning to FIG. 7, flowchart 700 is shown illustrating an example technique involving the provisioning of a virtual machine root key on an instance of a virtual machine in a particular host system. An attestation quote may be sent 705 from a secure key manager enclave to a secure key store system, which the key store system may use to ensure the trustworthiness of the key manager enclave. Based on a successful attestation, the key store system may potentially grant access multiple times to the same key manager enclave to potentially multiple different VM root keys for potentially multiple different VMs, all without requiring re-attestation of the key manager enclave. Accordingly, a key manager enclave may only perform an attestation once upon startup, without having to key manager enclave re-attest its trustworthiness to the key store system before the key manager enclave is closed and re-started on its corresponding host system. In some cases, the quote may be sent 705 when the key manager is first started (e.g., following a re-boot of its host system). In other cases, the quote may be sent 705 in connection with an initial attempt to register or fetch a VM root key with the key store system, among other examples.

Upon successful attestation of the key manager enclave with a key store of a system, the key manager enclave may participate in potentially multiple transactions with the key store to register and/or fetch VM root keys with/from the key store. The key manager enclave may engage in such transaction in response to a request received 710 at the key manager enclave from a VMM on the same host system. The request may identify that a particular root key is to be generated or fetched in connection with a launch of a particular VM instance on the host system. The key manager enclave may generate 715 a secure data control structure corresponding to the particular VM instance. In some cases, a separate secure data control structure may be generated 715 by the key manager enclave for each VM instance hosted on a particular host system. The key manager enclave is to use the data control structure to store a VM root key for the VM instance (among potentially other information relating to the VM instance). The key manager enclave may determine (e.g., 720) how to provision the request VM root key. If the VM root key has already been generated and registered to the particular VM instance (and stored) with the key store system the key manager enclave may send a request 725 to the key store system to obtain 730 the VM root key registered to the VM instance from the key store. The key manager enclave may then provision 735 the VM root key received from the key store system for the VM instance in the data control system for use during the VM instance.

In other instances, the key manager enclave may identify that no VM root key has yet been registered to a particular VM instance. For example, a request to launch a VM may identify whether or not a VM root key has already been registered, and the key manager enclave can determine how to obtain the VM root key for a particular VM instance based on information in the request. If a VM root key has not yet been registered to the particular VM instance, the key manager enclave may determine (e.g., at 740) whether it is to generate a new VM root key or use an existing (unregistered) key in the secure key store system. If a pre-generated VM root key is to be used, the key manager enclave may request 745 registration of one of the key store's existing keys to the particular VM instance. Again, the key store system may grant such a request based on the earlier attestation (e.g., at 705) of the key manager enclave. The key manager enclave may then receive 730 the newly-registered VM root key from the secure key store system and provision 735 the VM root key in the data control structure of the VM. In other cases, the key manager enclave may determine that it is to generate the VM root key. The key manager enclave may generate 750 the VM root key and then share the generated VM root key with the key store system to register 755 the VM root key to the VM instance with the key store system. The generated VM root key may then be maintained at the key store for future access and use in subsequent instantiations of the particular VM instance. In connection with registration of the generated VM root key, the key manager enclave may provision 735 the generated VM root key in the data control structure corresponding to the VM instance.

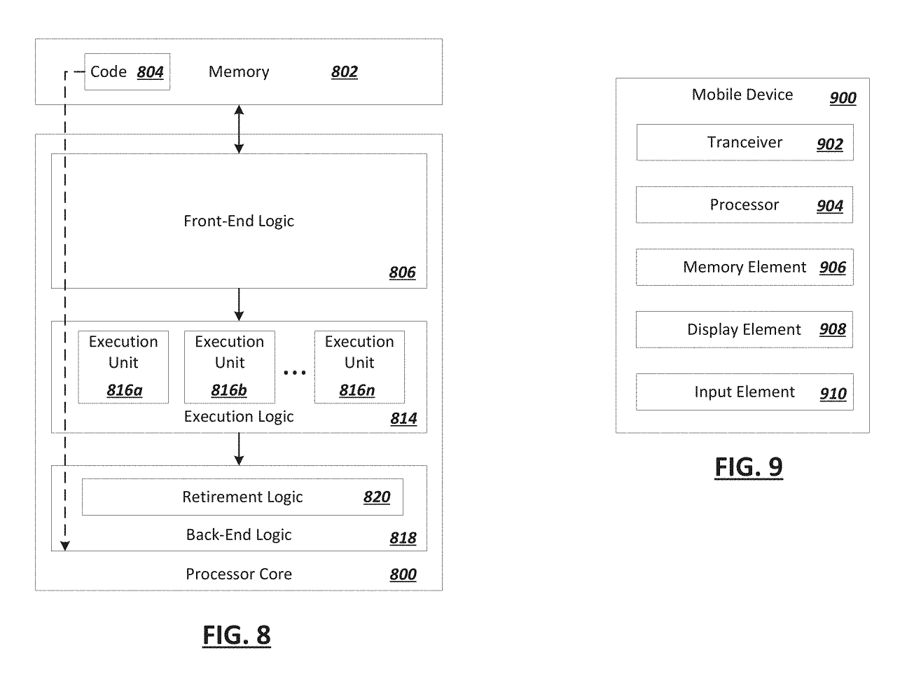

FIGS. 8-10 are block diagrams of exemplary computer architectures that may be used in accordance with embodiments disclosed herein. Other computer architecture designs known in the art for processors, mobile devices, and computing systems may also be used. Generally, suitable computer architectures for embodiments disclosed herein can include, but are not limited to, configurations illustrated in FIGS. 8-10.

FIG. 8 is an example illustration of a processor according to an embodiment. Processor 800 is an example of a type of hardware device that can be used in connection with the implementations above.

Processor 800 may be any type of processor, such as a microprocessor, an embedded processor, a digital signal processor (DSP), a network processor, a multi-core processor, a single core processor, or other device to execute code. Although only one processor 800 is illustrated in FIG. 8, a processing element may alternatively include more than one of processor 800 illustrated in FIG. 8. Processor 800 may be a single-threaded core or, for at least one embodiment, the processor 800 may be multi-threaded in that it may include more than one hardware thread context (or “logical processor”) per core.

FIG. 8 also illustrates a memory 802 coupled to processor 800 in accordance with an embodiment. Memory 802 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 800 can execute any type of instructions associated with algorithms, processes, or operations detailed herein. Generally, processor 800 can transform an element or an article (e.g., data) from one state or thing to another state or thing.

Code 804, which may be one or more instructions to be executed by processor 800, may be stored in memory 802, or may be stored in software, hardware, firmware, or any suitable combination thereof, or in any other internal or external component, device, element, or object where appropriate and based on particular needs. In one example, processor 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor 800 can also include execution logic 814 having a set of execution units 816a, 816b, 816n, etc. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor 800 allows out of order execution but requires in order retirement of instructions. Retirement logic 820 may take a variety of known forms (e.g., re-order buffers or the like). In this manner, processor 800 is transformed during execution of code 804, at least in terms of the output generated by the decoder, hardware registers and tables utilized by register renaming logic 810, and any registers (not shown) modified by execution logic 814.

Although not shown in FIG. 8, a processing element may include other elements on a chip with processor 800. For example, a processing element may include memory control logic along with processor 800. The processing element may include I/O control logic and/or may include I/O control logic integrated with memory control logic. The processing element may also include one or more caches. In some embodiments, non-volatile memory (such as flash memory or fuses) may also be included on the chip with processor 800.

Referring now to FIG. 9, a block diagram is illustrated of an example mobile device 900. Mobile device 900 is an example of a possible computing system (e.g., a host or endpoint device) of the examples and implementations described herein. In an embodiment, mobile device 900 operates as a transmitter and a receiver of wireless communications signals. Specifically, in one example, mobile device 900 may be capable of both transmitting and receiving cellular network voice and data mobile services. Mobile services include such functionality as full Internet access, downloadable and streaming video content, as well as voice telephone communications.

Mobile device 900 may correspond to a conventional wireless or cellular portable telephone, such as a handset that is capable of receiving “3G”, or “third generation” cellular services. In another example, mobile device 900 may be capable of transmitting and receiving “4G” mobile services as well, or any other mobile service.

Examples of devices that can correspond to mobile device 900 include cellular telephone handsets and smartphones, such as those capable of Internet access, email, and instant messaging communications, and portable video receiving and display devices, along with the capability of supporting telephone services. It is contemplated that those skilled in the art having reference to this specification will readily comprehend the nature of modern smartphones and telephone handset devices and systems suitable for implementation of the different aspects of this disclosure as described herein. As such, the architecture of mobile device 900 illustrated in FIG. 9 is presented at a relatively high level. Nevertheless, it is contemplated that modifications and alternatives to this architecture may be made and will be apparent to the reader, such modifications and alternatives contemplated to be within the scope of this description.

In an aspect of this disclosure, mobile device 900 includes a transceiver 902, which is connected to and in communication with an antenna. Transceiver 902 may be a radio frequency transceiver. Also, wireless signals may be transmitted and received via transceiver 902. Transceiver 902 may be constructed, for example, to include analog and digital radio frequency (RF) ‘front end’ functionality, circuitry for converting RF signals to a baseband frequency, via an intermediate frequency (IF) if desired, analog and digital filtering, and other conventional circuitry useful for carrying out wireless communications over modern cellular frequencies, for example, those suited for 3G or 4G communications. Transceiver 902 is connected to a processor 904, which may perform the bulk of the digital signal processing of signals to be communicated and signals received, at the baseband frequency. Processor 904 can provide a graphics interface to a display element 908, for the display of text, graphics, and video to a user, as well as an input element 910 for accepting inputs from users, such as a touchpad, keypad, roller mouse, and other examples. Processor 904 may include an embodiment such as shown and described with reference to processor 800 of FIG. 8.

In an aspect of this disclosure, processor 904 may be a processor that can execute any type of instructions to achieve the functionality and operations as detailed herein. Processor 904 may also be coupled to a memory element 906 for storing information and data used in operations performed using the processor 904. Additional details of an example processor 904 and memory element 906 are subsequently described herein. In an example embodiment, mobile device 900 may be designed with a system-on-a-chip (SoC) architecture, which integrates many or all components of the mobile device into a single chip, in at least some embodiments.

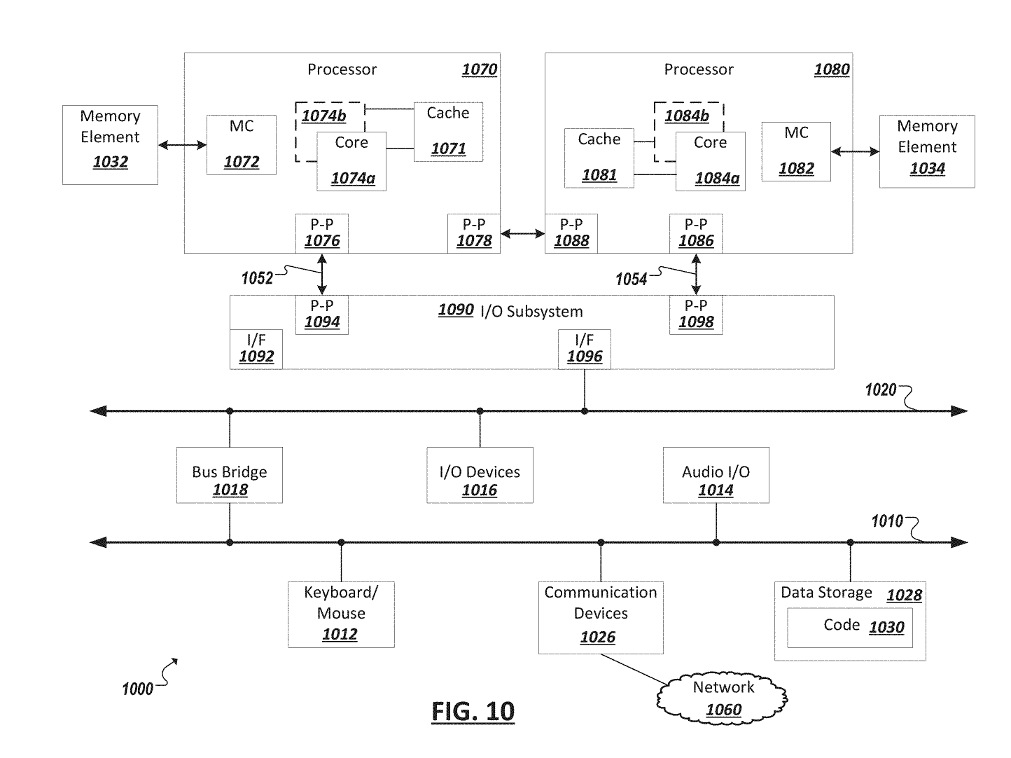

FIG. 10 illustrates a computing system 1000 that is arranged in a point-to-point (PtP) configuration according to an embodiment. In particular, FIG. 10 shows a system where processors, memory, and input/output devices are interconnected by a number of point-to-point interfaces. Generally, one or more of the computing systems described herein may be configured in the same or similar manner as computing system 1000.

Processors 1070 and 1080 may also each include integrated memory controller logic (MC) 1072 and 1082 to communicate with memory elements 1032 and 1034. In alternative embodiments, memory controller logic 1072 and 1082 may be discrete logic separate from processors 1070 and 1080. Memory elements 1032 and/or 1034 may store various data to be used by processors 1070 and 1080 in achieving operations and functionality outlined herein.

Processors 1070 and 1080 may be any type of processor, such as those discussed in connection with other figures. Processors 1070 and 1080 may exchange data via a point-to-point (PtP) interface 1050 using point-to-point interface circuits 1078 and 1088, respectively. Processors 1070 and 1080 may each exchange data with a chipset 1090 via individual point-to-point interfaces 1052 and 1054 using point-to-point interface circuits 1076, 1086, 1094, and 1098. Chipset 1090 may also exchange data with a high-performance graphics circuit 1038 via a high-performance graphics interface 1039, using an interface circuit 1092, which could be a PtP interface circuit. In alternative embodiments, any or all of the PtP links illustrated in FIG. 10 could be implemented as a multi-drop bus rather than a PtP link.

Chipset 1090 may be in communication with a bus 1020 via an interface circuit 1096. Bus 1020 may have one or more devices that communicate over it, such as a bus bridge 1018 and I/O devices 1016. Via a bus 1010, bus bridge 1018 may be in communication with other devices such as a keyboard/mouse 1012 (or other input devices such as a touch screen, trackball, etc.), communication devices 1026 (such as modems, network interface devices, or other types of communication devices that may communicate through a computer network 1060), audio I/O devices 1014, and/or a data storage device 1028. Data storage device 1028 may store code 1030, which may be executed by processors 1070 and/or 1080. In alternative embodiments, any portions of the bus architectures could be implemented with one or more PtP links.

The computer system depicted in FIG. 10 is a schematic illustration of an embodiment of a computing system that may be utilized to implement various embodiments discussed herein. It will be appreciated that various components of the system depicted in FIG. 10 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

The following examples pertain to embodiments in accordance with this Specification. One or more embodiments may provide an apparatus, a system, a machine readable storage, a machine readable medium, hardware- and/or software-based logic (e.g., memory buffer logic), and method to send an attestation data from a secure key manager enclave on a host computing system to a secure key store system, where the attestation data identifies attributes of the key manager enclave, at least a portion of the attestation data is signed by a host key rooted in hardware of the host computing system, and the attestation data attests to trustworthiness of the secure key manager enclave. A request is received at the key manager enclave to provide a root key for a particular virtual machine to be run on the host computing system, a secure data structure is generated in secure memory of the host computing system to be associated with the particular virtual machine, and the root key is provisioned in the secure data structure using the key manager enclave, where the key manager enclave is to have privileged access to the secure data structure.

In one example, a sealing key is to be derived from the root key and secret data of the particular virtual machine is to be sealed using the sealing key.

In one example, the root key is to be used in lieu of the hardware-based key of the host computing system to derive the sealing key.

In one example, the request identifies that the root key has been previously generated and a key request is sent to the secure key store system for the root key and the root key is received from the secure key store system in response to the key request and based on attestation of the key manager enclave to the key store system.

In one example, the root key is associated with the particular virtual machine and the key request identifies the particular virtual machine.

In one example, the root key was generated and stored on the secure key store system by another secure enclave on another host computing system.

In one example, the root key was generated in association with an initial instantiation of the virtual machine on the other host computing system.

In one example, the particular virtual machine is launched following a tearing down of the initial instantiation of the particular virtual machine.

In one example, access to the secure data structure is restricted to the key manager enclave.

In one example, the secure data structure includes a page of encrypted memory of the host computing system.

In one example, the particular virtual machine includes an initial instance of the particular virtual machine, and a request is sent to register the root key with the secure key store system as associated with the particular virtual machine.

In one example, the key manager enclave is to generate the root key, the request includes the root key, and registration and storage of the root key with the secure key store system is based on successful attestation of the key manager enclave to the secure key store system.

In one example, the root key is to be fetched from the secure key store system in association with launching instances of the particular virtual machine subsequent to registration of the root key.

In one example, a provisioning key is to be derived from the root key, the particular virtual machine is to include a secure provisioning enclave, and the secure provisioning enclave is to use the provisioning enclave to obtain another cryptographic key for use by the particular virtual machine.

In one example, the particular virtual machine further includes an application, an application enclave to communicate with a backend service for the application, and a quoting enclave to generate an attestation data for the application enclave, where the other cryptographic key includes an attestation key for use by the quoting enclave to sign at least a portion of the attestation data for the application enclave.

In one example, the root key is to be used in lieu of the hardware-based key of the host computing system to derive the provisioning key.

One or more embodiments may provide a system including at least one processor, at least one memory including secured memory, a virtual machine manager, and a secure key manager enclave. The virtual machine manager is to receive an instantiation request to launch a particular virtual machine on a particular one of a plurality of host computing systems. The secure key manager enclave is hosted on the particular host computing system and is to send an attestation data to a secure key store system, where the attestation data identifies attributes of the key manager enclave, at least a portion of the attestation data is signed by a host key rooted in hardware of the host computing system, and the attestation data attests to trustworthiness of the key manager enclave. A request is received at the key manager enclave, from the virtual machine manager, to provide a root key for a particular instantiation of a virtual machine to be run on the particular host computing system, where the root key is to be provisioned in a data control structure in the secured memory of the host computing system. The key manager enclave is to then provision the data control structure with the root key.

In one example, the system includes key generation logic on the particular host computing system to identify that the root key is to be used instead of the hardware-based key to derive one or more cryptographic keys for use in the particular instantiation of the virtual machine, and derive the one or more cryptographic keys from the root key.

In one example, the one or more cryptographic keys include a sealing key to seal and unseal sensitive data of the particular instance of the virtual machine.

In one example, the particular instance of the virtual machine includes a secure enclave to use the sealing key to seal the sensitive data.

In one example, the sensitive data is to be sealed within an image for the particular instance of the virtual machine.

In one example, the sensitive data is to be sealed within a remote data store accessible to two or more of plurality of host computing systems.

In one example, the particular instance of the virtual machine includes an application and the secure enclave includes an application enclave to secure aspects of the application.

In one example, the sensitive data includes an attestation key provisioned on the virtual machine.

In one example, the one or more cryptographic keys include a provisioning key to facilitate a request by the virtual machine for an attestation key.

In one example, the particular instance of the virtual machine includes an application, a quoting enclave to generate a first data corresponding to attestation of at least a portion of the application at least a portion of is signed by the attestation key, and a provisioning enclave to request the attestation key from a provisioning service, where the request for the attestation key includes a second data signed by the provisioning key, and provision the attestation key on the quoting enclave.

In one example, the system further includes the secure key store system, where the secure key store system is to maintain a respective root key for each one of a plurality of virtual machines to be launched in the plurality of host computing systems.

In one example, the secure key store system is to validate the attestation data and restrict access to the root keys if the attestation data cannot be validated.

In one example, the secure key store system is to maintain a positive attestation result for the key manager enclave based on the attestation data and grant the key manager enclave access to a plurality of root keys for a plurality of virtual machine instances, without re-attestation, based on the attestation data.

In one example, the system further includes a virtual machine scaling manager to identify a change in a deployment including a first set of virtual machine instances, and send the instantiation request to add the particular instance of the virtual machine to the first set of virtual machine instances and form a second set of virtual machine instances.

In one example, the key manager enclave is further to generate the control data structure in response to the request to provide the root key.

In one example, the key manager enclave has privileged access to the control data structure and the root key.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. At least one machine accessible storage medium having code stored thereon, the code when executed on a machine, causes the machine to:
send attestation data from a secure key manager enclave on a host computing system to a secure key store system, wherein the attestation data identifies attributes of the key manager enclave, at least a portion of the attestation data is signed by a host key rooted in hardware of the host computing system, and the attestation data attests to trustworthiness of the key manager enclave;
receive a request, at the key manager enclave, to provide a root key for a particular virtual machine to be run on the host computing system;
access the root key based on attestation of the key manager enclave to the key store system;
generate a secure data structure in secure memory of the host computing system to be associated with the particular virtual machine; and
provision the root key in the secure data structure using the key manager enclave, wherein the key manager enclave is to have privileged access to the secure data structure.

2. The storage medium of claim 1, wherein a sealing key is to be derived from the root key and secret data of the particular virtual machine is to be sealed using the sealing key.

3. The storage medium of claim 2, wherein the root key is to be used in lieu of the host key of the host computing system to derive the sealing key.

4. The storage medium of claim 1, wherein the request identifies that the root key has been previously generated and the code, when executed, further causes the machine to:
send a key request to the secure key store system for the root key; and
receive the root key from the secure key store system in response to the key request and based on attestation of the key manager enclave to the key store system.

5. The storage medium of claim 4, wherein the root key is associated with the particular virtual machine and the key request identifies the particular virtual machine.

6. The storage medium of claim 5, wherein the root key was generated and stored on the secure key store system by another secure enclave on another host computing system.

7. The storage medium of claim 6, wherein the root key was generated in association with an initial instantiation of the virtual machine on the other host computing system.

8. The storage medium of claim 7, wherein the particular virtual machine is launched following a tearing down of the initial instantiation of the particular virtual machine.

9. The storage medium of claim 1, wherein access to the secure data structure is restricted to the key manager enclave.

10. The storage medium of claim 1, wherein the secure data structure comprises a page of encrypted memory of the host computing system.

11. The storage medium of claim 1, wherein the particular virtual machine comprises an initial instance of the particular virtual machine, and accessing the root key comprises:
generating the root key using the key manager enclave; and
sending a request to register the root key with the secure key store system as associated with the particular virtual machine.

12. The storage medium of claim 11, wherein the request comprises the root key, and registration and storage of the root key with the secure key store system is based on successful attestation of the key manager enclave to the secure key store system.

13. The storage medium of claim 11, wherein the root key is to be fetched from the secure key store system in association with launching instances of the particular virtual machine subsequent to registration of the root key.

14. The storage medium of claim 1, wherein a provisioning key is to be derived from the root key, the particular virtual machine is to comprise a secure provisioning enclave, and the secure provisioning enclave is to use the provisioning enclave to obtain another cryptographic key for use by the particular virtual machine.

15. A method comprising:
sending an attestation data from a secure key manager enclave on a host computing system to a secure key store system, wherein the attestation data identifies attributes of the key manager enclave, at least a portion of the attestation data is signed by a host key of the host computing system, and the attestation data attests to trustworthiness of the secure key manager enclave;
receiving a request, at the key manager enclave, to provide a root key for a particular virtual machine to be run on the host computing system;
generating a secure data structure in secure memory of the host computing system to be associated with the particular virtual machine;
accessing the root key based on attestation of the key manager enclave at the key store system; and
provisioning the root key in the secure data structure using the key manager enclave, wherein the key manager enclave is to have privileged access to the secure data structure.

16. A system comprising:
at least one processor;
at least one memory comprising secured memory;
a virtual machine manager to:
receive an instantiation request to launch a particular virtual machine on a particular one of a plurality of host computing systems;
a secure key manager enclave hosted on the particular host computing system, wherein the secure key manager enclave is to:
send an attestation data to a secure key store system, wherein the attestation data identifies attributes of the key manager enclave, at least a portion of the attestation data is signed by a host key of the host computing system, and the attestation data attests to trustworthiness of the key manager enclave;
receive a request, from the virtual machine manager, to provide a root key for a particular instantiation of a virtual machine to be run on the particular host computing system, wherein the root key is to be provisioned in a data control structure in the secured memory of the host computing system; and
provision the data control structure with the root key.

17. The system of claim 16, further comprising the secure key store system, wherein the secure key store system is to maintain a respective root key for each one of a plurality of virtual machines to be launched in the plurality of host computing systems.

18. The system of claim 17, wherein the secure key store system is to validate the attestation data and restrict access to the root keys if the attestation data cannot be validated.

19. The system of claim 17, wherein the secure key store system is to maintain a positive attestation result for the key manager enclave based on the attestation data and grant the key manager enclave access to a plurality of root keys for a plurality of virtual machine instances, without re-attestation, based on the attestation data.

20. The system of claim 16, further comprising a virtual machine scaling manager to:
identify a change in a deployment comprising a first set of virtual machine instances; and
send the instantiation request to add the particular instance of the virtual machine to the first set of virtual machine instances and form a second set of virtual machine instances.
